(19) United States
(12) Patent Application Publication
(10) Pub. No.: US 2005/0055722 A1
(43) Pub. Date: Mar. 10, 2005

(54) Intelligent routing of digital content

(75) Inventor: Kevin Lym, San Jose, CA (US)

Correspondence Address: Jonathan O. Owens;HAVERSTOCK & OWENS LLP, 162 North Wolfe Road, Sunnyvale, CA, 94086, US

(73) Assignees: Sony Corporation; Sony Electronics, Inc.

(21) Appl. No.: 10/658,929

(22) Filed: Sep. 9, 2003

(51) Int. Cl. H04N 7/173; H04N 7/18; H04N 7/00; H04N 7/16; H04N 11/00

(52) U.S. Cl. 725/80; 725/74; 725/132; 725/152; 348/552

(57) ABSTRACT

An application which automatically routes digital content to secondary devices overcomes the traditional problems present with downloading content to secondary devices. The digital content preferably includes file types such as movies, music, images, or anything else that might be stored on a secondary device like an MP3 player or a video recorder. Initially the user must download digital content from a server to the user's computer or set-top box. The routing application compares the file types or alternatively, meta data, of the downloaded content with set values that determine where the content is routed. When the secondary devices are coupled to the computer, the application determines, based on its current settings, which file type is routed to which secondary device and then distributes the files to the appropriate device.

### FIELD OF THE INVENTION

The present invention relates to the field of routing digital content. More specifically, the present invention relates to a software program for routing digital content to secondary devices from a primary device.

### BACKGROUND OF THE INVENTION

In the past, to store digital content on a secondary device such as an MP3 player or a video recorder, the user had to download the content from a server to his personal computer or set-top box and then manually download the content to the secondary device. Furthermore, if the user downloaded a large amount of content which included music, movies, and any other files, the user had to sort through the data, making sure to route the appropriate file type to the appropriate secondary device.

A few technologies have been developed to make this process easier by automating the download procedure once the secondary device is connected to the computer, but these devices still leave room for improvement.

The Palm™ HotSync® Cradle automatically updates a handheld device by synchronizing the handheld with the computer it is connected to. The user must first specify which folders on the computer are to be targeted for download or a default folder may be used. Then, by placing the handheld in the HotSync® Cradle, the handheld will download any new files in that folder to the handheld. Furthermore, any programs in that directory will be installed on the handheld device.

In this setup, each individual secondary device must be specifically configured to locate a specified folder and then download the files in that folder. Furthermore, the user must perform each of the following operations manually for the download to work: the initial configuration of which folder to obtain the content, the separation of the content into folders per device, and when ready, manual insertion of the handheld into the cradle to initiate the download. These steps can be a time consuming and tedious process for the user; specifically the sorting of each type of file into different folders per each secondary device.

MiniMusic is another product that utilizes the HotSync® technology to synchronize a secondary device with a computer. Similar to the Palm™ HotSync® Cradle, the user must manually specify which folder to synchronize with, place all of the appropriate files into that folder, and then physically connect the secondary device to the computer to initiate the download. These are essentially the same problems with the Palm™ HotSync® Cradle in that it is time consuming because the process is done manually instead of automatically.

### SUMMARY OF THE INVENTION

An application which allows a computing device to automatically route digital content to secondary devices overcomes the traditional problems present with downloading content to secondary devices. The digital content preferably includes file types such as movies, music, images, or anything else that might be stored on a secondary device like an MP3 player, a video recorder, or other handheld device. Initially the user must download digital content from a server to the user's computer or set-top box. The digital content is stored on the computer's storage device, such as a hard disk drive, which is also where the routing software is kept. Alternatively, the storage device is a semiconductor memory such as a memory card, memory stick or flash memory. The routing software compares the file types of the content with user-defined values stored in a routing table that determine to which secondary device the content is to be routed. For instance, the user may associate a file type of .avi for a movie, and the software will route the file to a video recorder whereas a file with a file type of .mp3 will be routed to an MP3 player. Hence, when the secondary devices are coupled to the computer, the application will determine, based on its settings, which file type is to be routed to which secondary device and will distribute the files to the appropriate device. Alternatively, the routing software utilizes meta data associated with the content to determine to which secondary device the content is to be routed. Additionally, if a secondary device is not coupled when the software attempts to automatically download the content, the storage device on the computer will retain the content until the secondary device is ready. Ultimately the digital content is routed to and stored on the secondary device.

In a first aspect of the invention, an apparatus for automatically routing digital information, comprises an interface coupled to receive downloaded digital information having a type, a storage device coupled to the interface to store the digital information and a controller coupled to the storage device to automatically sort and distribute the digital information based on the type to one or more secondary devices. The digital information is preferably downloaded from a server to the storage device. The storage device is preferably a hard disk drive. Alternatively, the storage device is a semiconductor memory. The digital information preferably comprises media content including music, videos, and data. The controller utilizes a routing table to route the digital information. The routing table further comprises a file type column and a device column. Alternatively, the routing table utilizes meta data information within the digital information to route the digital information. The routing table is preferably user-defined. The controller automatically detects one or more secondary devices. The secondary devices preferably include one or more of an mp3 player, a video recorder, and a handheld.

In another aspect of the present invention, an apparatus for automatically routing digital information from a computing device to one or more secondary devices, comprises an interface coupled to receive downloaded digital information having a type and a storage device coupled to the interface to store the digital information, a controller coupled to the storage device to automatically: detect the one or more secondary devices; determine which type of digital information is routed to which secondary device and distribute the digital information to the one or more secondary devices based on the type. The digital information is preferably downloaded from a server to the storage device. The storage device is preferably a hard disk drive. Alternatively, the storage device is a semiconductor memory. The digital information preferably comprises media content including music, videos, and data. The controller utilizes a routing table to route the digital information. The routing table further comprises a file type column and a device column. Alternatively, the routing table utilizes meta data information within the digital information to route the digital information. The routing table is preferably user-defined. The secondary devices preferably include one or more of an mp3 player, a video recorder, and a handheld.

In a further aspect of the present invention, an apparatus for automatically routing digital media content from a computing device to one or more secondary devices comprises an interface coupled to receive downloaded digital media content having a type, a storage device coupled to the interface to store the digital media content and a controller coupled to the storage device to automatically: detect the one or more secondary devices; determine which type of media content is routed to which secondary device utilizing a routing table; and distribute the digital media content to the one or more secondary devices based on the type. The digital media content is preferably downloaded from a server to the storage device. The storage device is preferably a hard disk drive. Alternatively, the storage device is a semiconductor memory. The digital media content preferably includes music, videos, and data. The routing table further comprises a file type column and a device column. Alternatively, the routing table utilizes meta data information within the digital information to route the digital information. The routing table is user-defined. The secondary devices preferably include one or more of an mp3 player, a video recorder, and a handheld.

In still a further aspect of the present invention, a network of devices for automatically routing digital information comprises a server including digital information, a computing device coupled to the server for obtaining and routing the digital information and one or more secondary devices coupled to the computing device for receiving the digital information from the computing device. The digital information preferably comprises media content including music, videos, and data. The computing device further comprises an interface coupled to receive the digital information having a type, a storage device coupled to the interface to store the digital information and a controller coupled to the storage device to automatically sort and distribute the digital information based on the type to one or more secondary devices. The controller automatically detects the one or more secondary devices. The storage device is preferably a hard disk drive. Alternatively, the storage device is a semiconductor memory. The computing device is preferably a personal computer. Alternatively, the computing device is a set-top box. The computer device further comprises a modem device for coupling to the server. The secondary devices preferably comprise an mp3 player, a video recorder, and a handheld device.

In yet a further aspect of the present invention, a method for routing digital information from a computing device to one or more secondary devices, comprises receiving the digital information having a type, automatically sorting the digital information based on the type and automatically distributing the digital information to a corresponding one or more of the secondary devices based on the type. The method further comprises downloading the digital information from a server to the computing device. The method further comprises automatically detecting the secondary devices. The method further comprises storing the digital information in the computing device until the corresponding one or more of the secondary devices is coupled to the computing device.

In yet another aspect of the present invention, a method for routing digital information from a computing device to one or more secondary devices, comprises receiving the digital information having a type, automatically detecting the secondary devices, automatically sorting the digital information based on the type and automatically distributing the digital information to a corresponding one or more of the secondary devices based on the type. The method further comprises downloading the digital information from a server to the computing device. The method further comprises storing the digital information in the computing device until the corresponding one or more of the secondary devices is coupled to the computing device.

### BRIEF DESCRIPTION OF THE DRAWINGS

FIG. 1 illustrates a block diagram of the system including the server, computing device, and secondary devices of the preferred embodiment of the present invention.

FIG. 2 illustrates a block diagram of the components of the computing device including the central processing unit and hard disk drive where the digital content is stored as well as the programs for manipulating the content of the preferred embodiment of the present invention.

FIG. 3 illustrates a routing table for directing which file type is routed to which secondary device of the preferred embodiment of the present invention.

FIG. 4 illustrates a block diagram of the process required to transfer digital content to a secondary device.

FIG. 5 illustrates a flowchart of the preferred method of routing digital information to secondary devices.

FIG. 6 illustrates a flowchart of the preferred method of routing digital information using an exemplary routing table.

### DETAILED DESCRIPTION OF A PREFERRED EMBODIMENT

An application on a computing device for automatically routing digital content to secondary devices overcomes the traditional problems present with downloading content to secondary devices. The digital content preferably includes file types such as movies, music, images, or anything else that might be stored on a secondary device like an MP3 player or a video recorder. Initially the user downloads digital content from a server to the user's computer or other computing device. The routing software detects which secondary devices are coupled to the computing device. The routing software then compares the file types of the content with set values that determine where the content is routed. Hence, when the secondary devices are coupled to the computer, the software will determine based on its current settings which file type is routed to which secondary device and will distribute the files to the appropriate device. Alternatively, the routing software utilizes meta data associated with the content to determine to which secondary device the content is to be routed.

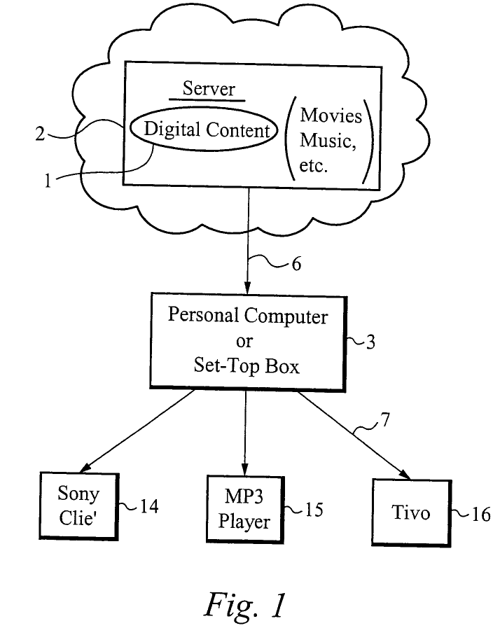

FIG. 1 illustrates a block diagram of the system of the preferred embodiment of the present invention. The system primarily includes a server 2, a computing device 3, and one or more secondary devices, such as a Sony Clié™ handheld device 14, an MP3 player 15, or a Tivo™ 16 video recorder device. The server 2 initially stores digital content 1 available for download. The server 2 is coupled to the computing device 3 by any appropriate connection 6, including a modem or a dsl-modem used in conjunction with telephone lines, a cable modem via cable lines, a wireless connection or any other appropriate connection. The user downloads the digital content 1 to the computing device 3 from the server 2. The computing device is any appropriate device such as a personal computer, a laptop, or a set-top box. Routing software stored on the computing device 3 detects which secondary devices 5 are coupled to the computing device 3. The secondary devices 5 are coupled to the computing device 3 by any appropriate connection 7 such as serial cables, USB, IEEE 1394, or a wireless connection. The computing device 3 then automatically routes the digital content 1 to one or more of the secondary devices 5 depending on the file type or alternatively, utilizing meta data associated with the content. The digital content 1 is finally stored on the appropriate secondary device 5.

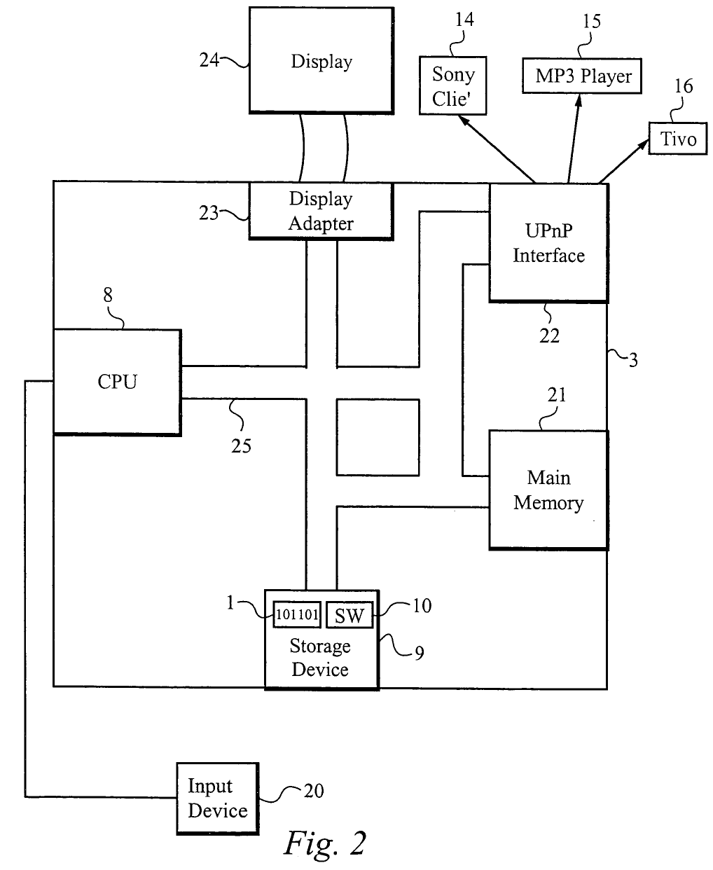

FIG. 2 illustrates a block diagram of an exemplary computing device 3 performing the automatic content routing of the present invention. The computing device 3 comprises a central processing unit (CPU) 8, a storage device 9, a display adapter 23, a main memory 21, a UPnP interface 22, all coupled together by a system bus 25. The storage device 9 stores the digital content 1 downloaded from the server and the routing software application 10, of the present invention. The storage device 9 may include both fixed and removable media using any one or more of magnetic, optical or magneto-optical storage technology or any other available storage technology. The CPU 8 controls the computing device 3 by performing the operations described by the routing software 10. The routing software 10 detects the secondary devices 5 and automatically routes the digital content to the appropriate secondary device 5. The UPnP interface 22 preferably operates according to the UPnP protocol and couples the computing device 3 to the exemplary secondary devices including the Sony Clié™ handheld device 14, the MP3 player 15, or a Tivo 16 video recorder device. The system bus 25 contains an address bus for addressing any portion of the memory 21 and the storage device 9. The system bus 21 also includes a data bus for transferring data between and among the CPU 8, the main memory 21, the display adapter 23, the storage device 9 and the UPnP interface 22.

The computing device 3 is also coupled to a number of peripheral input and output devices including the input device 20 and the associated display 24. The input device 20 may be any appropriate input device including a keyboard, mouse, touch screen or stylus. The display adapter 23 interfaces between the components within the computing device 3 and the display 24. The display adapter 24 converts data received from the components within the computing device 3 into signals which are used by the display 24 to generate images for display.

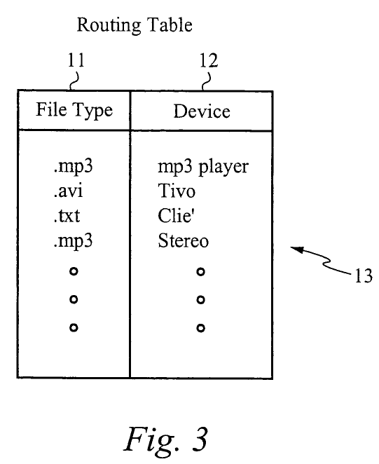

FIG. 3 illustrates a block diagram of an exemplary routing table used by the routing software. On one side of the table is a “file type” column 11 and on the other side is a corresponding “device” column 12. In this example, a file of file type, .mp3, corresponds with an MP3 player, so the application will automatically route all downloaded files of type, .mp3, to the MP3 player. Furthermore, if a file type is to be distributed to multiple secondary devices, it can be done by including the file type for each of the multiple corresponding secondary devices. For instance, if the user's stereo also stores .mp3 files, the user can pair .mp3 files with an MP3 player and a stereo, such that the files will go to both secondary devices. For files of other types, such as .txt or .avi, those will be routed similarly to the appropriate device, specified within the routing table 13. When the user specifies .txt files to be routed to a handheld, and .avi files to be routed to a video recorder, each downloaded file of the specified type will be automatically routed to the specified device. As described above, alternatively, the routing software utilizes meta data associated with the content to determine to which secondary device the content is to be routed.

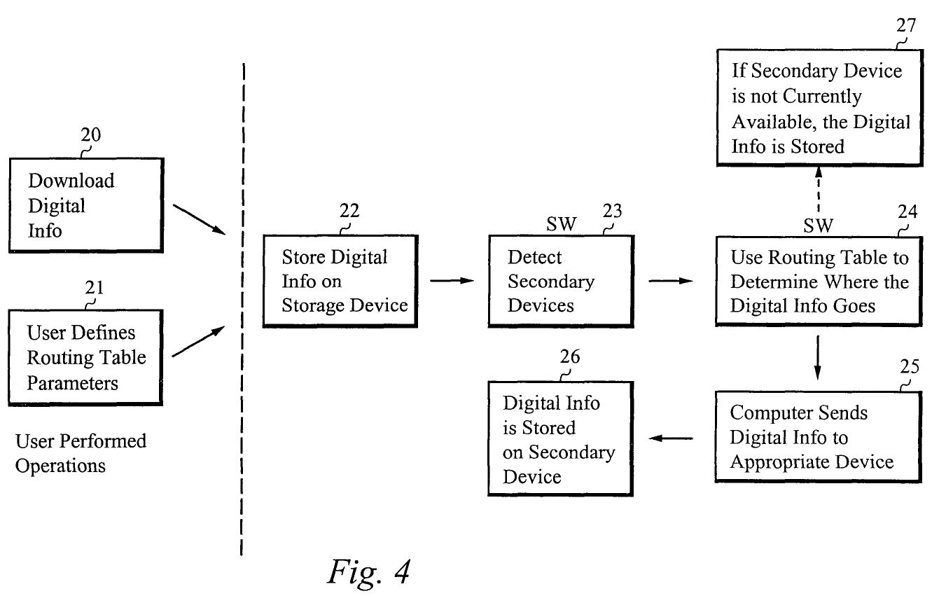

FIG. 4 illustrates a block diagram of the process by which the digital content is transferred to a secondary device. The user initially performs two operations before the routing software begins routing the digital information. The user downloads the digital information at the block 20 and defines the routing table parameters at the block 21. The digital information is stored on the storage device at the block 22 and then the routing software performs its duties. The software first detects any connected secondary devices at the block 23. Then the software utilizes the routing table and determines to which device to route the digital information at the block 24. The computing device then routes the digital information to the appropriate secondary device at the block 25 where that information will ultimately be stored at the block 26. If the secondary device is unavailable, because the secondary device is not currently connected, then the digital information is stored on the storage device at the block 27 until the secondary device becomes available, then the software will route the digital information to the secondary device.

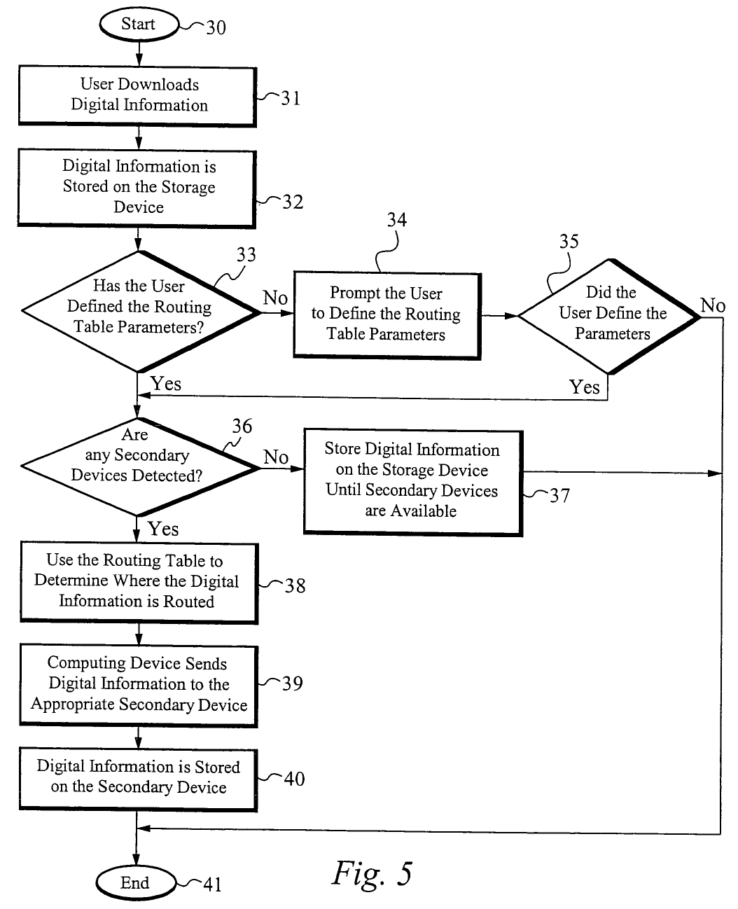

FIG. 5 illustrates a flowchart of the preferred method of routing digital information to secondary devices. The preferred method begins at the step 30. At the step 31, a user downloads digital information from a server to a computing device. The digital information is stored on a storage device of the computing device at the step 32. At the step 33, it is determined if the user has defined the routing table parameters. If it is determined that the user has defined the routing table parameters, then the computing device will attempt to detect secondary devices at the step 36. However, if the user has not defined the routing table parameters, the program will prompt the user to define the parameters at the step 34. It is then determined at the step 35 if the user has defined parameters for the downloaded content type. If it is determined that the user has defined parameters at the step 35, the program will attempt to detect any secondary devices at the step 36. If it is determined at the step 35 that the user has not yet defined parameters for the downloaded content type, the program will end in the step 41. At the step 36, if any secondary devices are detected, the routing table will determine where the digital information is to be routed at the step 38. However, if the secondary devices are not detected at the step 36, the digital information is stored on the storage device at the step 37 until secondary devices are available and the program will end at the step 41. After the routing table determines where the digital information is to be routed at the step 38, the computing device routes the digital information to the appropriate secondary device at the step 39. At the step 40, the digital information is stored on the secondary device, and ultimately the program ends at the step 41.

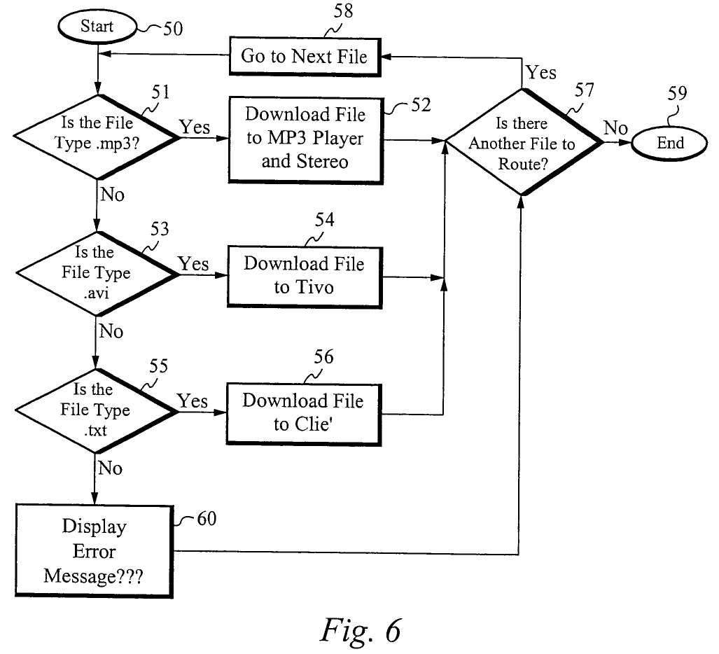

FIG. 6 illustrates a flowchart of the preferred method of routing digital information using an exemplary routing table. The exemplary routing table 13, as illustrated in FIG. 3 and discussed above, has a column of file types 11 comprising .mp3, .avi, .txt, and .mp3 which respectively correspond to a column of devices 12 comprising an MP3 player, a Tivo, a Clié™, and a stereo. The method of FIG. 6 starts at the step 50. At the step 51, it is determined if the file being routed to a secondary device has a file type .mp3. If it is determined at the step 51 that the file is of the type .mp3, the file will be downloaded to the MP3 player and the stereo at the step 52 since in the exemplary routing table 13, the file type .mp3 corresponds to the MP3 player and the stereo. If it is determined at the step 51 that the file type is not .mp3, then the program checks if the file type is .avi at the step 53. If it is determined at the step 53 that the file type is .avi, then the file is downloaded to the Tivo device at the step 54 because the file type .avi is associated with the Tivo device. However, if it is determined at the step 53 that the file type is not .avi, it is then determined at the step 55 if the file type is .txt. If it is determined at the step 55 that the file type is .txt, then the file is downloaded to the Clié™ handheld device at the step 56.

After each of the download steps 52, 54, and 56 where the file is downloaded to the appropriate secondary device, it is determined at the step 57 if there is another file to route. If it is determined at the step 57 that there is another downloaded file to route, then the program proceeds to the next file at the step 58 and returns to the step 51 to determine if the next file is of the file type .mp3. If it is determined at the step 57 that there is not another file to route, the program then ends at the step 59. However, if it is determine at the step 55 that the file type is not .txt, then an error message is displayed at the step 60 that the file type did not correspond to any of the specified devices included in the routing table 13. After displaying the message at the step 60, the program then jumps to the step 57 to determine if there is another file to route. If it is determined at the step 57 that there is no other file to route, then the program will end at the step 59.

The system begins with the server 2 which initially stores digital content 1 available for download. The server 2 may be coupled to the computing device 3 via a number of different links 6, such as DSL, cable, or wireless connections to the server. The user downloads the digital content 1 from the server 2 to the storage device 9 of the computing device 3. Routing software 10 stored on the storage device 9 of the computing device 3 first detects which secondary devices 14, 15 and 16 are coupled to the computing device 3. The routing software 10 utilizes a routing table 13 to determine which file type is routed to which secondary device 14, 15 and 16. The routing table 13 has a list of the file types and a list of the corresponding secondary devices 14, 15 and 16. Based on the lists, the routing software 10 then automatically routes the digital content 1 to one or more of the secondary devices 14, 15 and 16. The digital content 1 is then finally stored on the appropriate secondary device 14, 15 and 16. If the secondary device or devices 14, 15 and 16 are not currently available for the file transfer when the digital content is downloaded, the digital content 1 is stored on the storage device 9 of the computing device 3 until the appropriate secondary device 14, 15 and 16 becomes available.

To utilize the routing software, the user only needs to perform a few minor tasks. The user must define which type of file is associated with which type of secondary device. Alternatively, the user defines which type of meta data information is associated with which type of secondary device. The user also has to download the digital information and ensure the secondary devices are coupled to the computing device. Aside from those tasks, the routing software automatically manages the transfer of content to the secondary devices.

The present invention alleviates many of the burdens of manually transferring files from a computing device to a secondary device. By implementing a software scheme that automatically sorts digital content based on file type, and using that file type to transfer the digital content to one or more secondary devices, the user no longer has the tedious task of sorting and storing such content manually. This software and system of the present invention, will save both time and money for the user, and further brings individual devices such as MP3 players closer to the Internet by including them in one automated system.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims. Specifically, it will be apparent to those skilled in the art that while in the preferred embodiment of the present invention the computer system 3 is coupled to the server 2 over the internet, the computer system 3 could also be coupled to the server 2 through any other appropriate communication structures, including intranets, direct connections and the like. Also, it will be apparent to those skilled in the art that the routing application of the present invention can be used to download and route any appropriate type of content to any appropriate type of secondary device.

1. An apparatus for automatically routing digital information, comprising:
a. an interface coupled to receive downloaded digital information having a type;
b. a storage device coupled to the interface to store the digital information; and
c. a controller coupled to the storage device to automatically sort and distribute the digital information based on the type to one or more secondary devices.

2. The apparatus as claimed in claim 1 wherein the digital information is downloaded from a server to the storage device.

3. The apparatus as claimed in claim 1 wherein the storage device is a hard disk drive.

4. The apparatus as claimed in claim 1 wherein the storage device is a semiconductor memory.

5. The apparatus as claimed in claim 1 wherein the digital information comprises media content including music, videos, and data.

6. The apparatus as claimed in claim 1 wherein the controller utilizes a routing table to route the digital information.

7. The apparatus as claimed in claim 6 wherein the routing table further comprises a file type column and a device column.

8. The apparatus as claimed in claim 6 wherein the routing table utilizes meta data information within the digital information to route the digital information.

9. The apparatus as claimed in claim 6 wherein the routing table is user-defined.

10. The apparatus as claimed in claim 1 wherein the controller automatically detects one or more secondary devices.

11. The apparatus as claimed in claim 1 wherein the secondary devices include one or more of an mp3 player, a video recorder, and a handheld.

12. An apparatus for automatically routing digital information from a computing device to one or more secondary devices, comprising:
a. an interface coupled to receive downloaded digital information having a type;
b. a storage device coupled to the interface to store the digital information; and
c. a controller coupled to the storage device to automatically:
i. detect the one or more secondary devices;
ii. determine which type of digital information is routed to which secondary device; and
iii. distribute the digital information to the one or more secondary devices based on the type.

13. The apparatus as claimed in claim 12 wherein the digital information is downloaded from a server to the storage device.

14. The apparatus as claimed in claim 12 wherein the storage device is a hard disk drive.

15. The apparatus as claimed in claim 12 wherein the storage device is a hard disk drive.

16. The apparatus as claimed in claim 12 wherein the digital information comprises media content including music, videos, and data.

17. The apparatus as claimed in claim 12 wherein the controller utilizes a routing table to route the digital information.

18. The apparatus as claimed in claim 17 wherein the routing table further comprises a file type column and a device column.

19. The apparatus as claimed in claim 17 wherein the routing table utilizes meta data information within the digital information to route the digital information.

20. The apparatus as claimed in claim 17 wherein the routing table is user-defined.

21. The apparatus as claimed in claim 12 wherein the secondary devices include one or more of an mp3 player, a video recorder, and a handheld.

22. An apparatus for automatically routing digital media content from a computing device to one or more secondary devices comprising:
a. an interface coupled to receive downloaded digital media content having a type;
b. a storage device coupled to the interface to store the digital media content; and
c. a controller coupled to the storage device to automatically:
i. detect the one or more secondary devices;
ii. determine which type of media content is routed to which secondary device utilizing a routing table; and
iii. distribute the digital media content to the one or more secondary devices based on the type.

23. The apparatus as claimed in claim 22 wherein the digital media content is downloaded from a server to the storage device.

24. The apparatus as claimed in claim 22 wherein the storage device is a hard disk drive.

25. The apparatus as claimed in claim 22 wherein the storage device is a semiconductor memory.

26. The apparatus as claimed in claim 22 wherein the digital media content includes music, videos, and data.

27. The apparatus as claimed in claim 22 wherein the routing table further comprises a file type column and a device column.

28. The apparatus as claimed in claim 22 wherein the routing table utilizes meta data information within the digital information to route the digital information.

29. The apparatus as claimed in claim 22 wherein the routing table is user-defined.

30. The apparatus as claimed in claim 22 wherein the secondary devices include one or more of an mp3 player, a video recorder, and a handheld.

31. A network of devices for automatically routing digital information comprising:
a. a server including digital information;
b. a computing device coupled to the server for obtaining and routing the digital information; and
c. one or more secondary devices coupled to the computing device for receiving the digital information from the computing device.

32. The network of devices as claimed in claim 31 wherein the digital information comprises media content including music, videos, and data.

33. The network of devices as claimed in claim 31 wherein the computing device further comprises:
a. an interface coupled to receive the digital information having a type;
b. a storage device coupled to the interface to store the digital information; and
c. a controller coupled to the storage device to automatically sort and distribute the digital information based on the type to one or more secondary devices.

34. The network of devices as claimed in claim 33 wherein the controller automatically detects the one or more secondary devices.

35. The network of devices as claimed in claim 33 wherein the storage device is a hard disk drive.

36. The network of devices as claimed in claim 33 wherein the storage device is a semiconductor memory.

37. The network of devices as claimed in claim 31 wherein the computing device is a personal computer.

38. The network of devices as claimed in claim 31 wherein the computing device is a set-top box.

39. The network of devices as claimed in claim 31 wherein the computer device further comprises a modem device for coupling to the server.

40. The network of devices as claimed in claim 31 wherein the secondary devices comprise an mp3 player, a video recorder, and a handheld device.

41. A method for routing digital information from a computing device to one or more secondary devices, comprising:
a. receiving the digital information having a type;
b. automatically sorting the digital information based on the type; and
c. automatically distributing the digital information to a corresponding one or more of the secondary devices based on the type.

42. The method as claimed in claim 41 further comprising downloading the digital information from a server to the computing device.

43. The method as claimed in claim 41 further comprising automatically detecting the secondary devices.

44. The method as claimed in claim 41 further comprising storing the digital information in the computing device until the corresponding one or more of the secondary devices is coupled to the computing device.

45. A method for routing digital information from a computing device to one or more secondary devices, comprising:
a. receiving the digital information having a type;
b. automatically detecting the secondary devices;
c. automatically sorting the digital information based on the type; and
d. automatically distributing the digital information to a corresponding one or more of the secondary devices based on the type.

46. The method as claimed in claim 45 further comprising downloading the digital information from a server to the computing device.

47. The method as claimed in claim 45 further comprising storing the digital information in the computing device until the corresponding one or more of the secondary devices is coupled to the computing device.
